(19) United States
(12) Patent Application Publication
(10) Pub. No.: US 2004/0236587 A1
(43) Pub. Date: Nov. 25, 2004

(54) Lifecycle profitability tool for leasable assets

(75) Inventor: Dan A. Nalawade, Redding, CT (US)

Correspondence Address: LEE & HAYES PLLC, SUITE 500, 421 W RIVERSIDE, SPOKANE, WA, 99201

(73) Assignee: GENERAL ELECTRIC COMPANY, SCHENECTADY, NY (US)

(21) Appl. No.: 10/444,480

(22) Filed: May 23, 2003

(51) Int. Cl. G06F 17/60

(52) U.S. Cl. 705/1

(57) ABSTRACT

A lifecycle profitability (LCP) tool is provided to determine the lifecycle profitability of a leasable asset. The lifecycle profitability tool accepts lease terms entered by a user for leasing the asset, and then computes the lifecycle profitability of the asset based on the lease terms. The tool presents results of the computation to the user in a form that conveys to the user whether this individual lease, given the entered terms, is financially acceptable or not.

### TECHNICAL FIELD

The invention relates to profitability tools, and more particularly to profitability tools for leasable assets.

### BACKGROUND

A potential lessor's evaluation of a long term lease of an asset can be difficult, considering the complexity of many current leases, and what may happen to the assets after the termination of the applicable leases. A potential lessor or its salesperson is often unable to ascertain long term financial implications of the lease. Even if the lessor or salesperson has data relating to the lease and the underlying assets, it is difficult to apply that data and convey the results in a manner that can be comprehended, especially in a negotiation where terms of the lease, including duration, pricing and other issues, may be varied and may have a direct effect on the profitability of the transaction. It is difficult for the lessor or its salesperson to discern whether a proposed lease deal is in fact a good deal financially and therefore whether the lease should be entered into. It is also difficult to determine what lease terms are required to make a particular lease a good deal.

There is a need for a technique for a potential lessor under a lease deal to determine whether the deal is a good deal or a poor deal, and what lease term is required to make a potential deal a good deal in a manner that can be rapidly discerned by a user.

### SUMMARY

A lifecycle profitability tool for determining the lifecycle profitability to the lessor of a leasable asset is described. The lifecycle profitability tool accepts lease terms entered by a user for leasing a particular asset, and then computes the lifecycle profitability of the asset based on the lease terms. The tool presents results of the computation to the user in a form that conveys to the user whether this individual lease, given the entered terms, is financially acceptable or not.

In one implementation, the lifecycle profitability tool includes a memory, a user interface, and a processor. The memory stores a collection of data that pertains financially to the leasable asset. The data may be periodically updated, for example, by periodically loading updated data into the memory or by retrieval in real time from a remote data server. The user interface facilitates entry of the lease terms pertaining to leasing of the leasable asset. The processor computes a lifecycle profitability of the leasable asset over the life of a deal relating to the asset based on the data in the data store given the lease variables entered via the user interface. The results are then presented to the user via the user interface. Additionally, the tool may be configured with color-coded fields that signify whether the lease is financially satisfactory to the lessor, as well as graphical plots showing the lifecycle profitability to the lessor of the asset given this particular set of lease terms.

### BRIEF DESCRIPTION OF THE DRAWINGS

The same numbers are used throughout the drawings to reference like features and components.

FIG. 1 shows an exemplary computer environment in which a life cycle profitability (LCP) tool can be implemented.

FIG. 2 shows another computer environment in which a LCP tool can be implemented.

FIG. 3 shows an exemplary computer display showing one embodiment of a LCP tool.

FIG. 4 shows an exemplary data input/data output portion of the displayed LCP tool shown on FIG. 3 having fictional input and output terms.

FIG. 5 shows an exemplary graphical output portion of the displayed LCP tool shown in FIG. 3 having fictional values presented in graphs.

FIG. 6 is a flow diagram of an exemplary process for the LCP tool.

### DETAILED DESCRIPTION

Any lessor entering into a lease deal desires to improve the lease's terms from its point of view. Most leases are becoming increasingly complex and difficult to evaluate, especially in light of possible subsequent uses of the underlying assets.

When an asset (such as a tangible asset) is being leased, it is often difficult for a lessor to determine quickly and reliably whether a potential lease is a good deal from a financial perspective, and therefore whether the lease should be entered into. In this disclosure, tangible assets are considered to be products that typically have a finite life. The assets involved in this disclosure are also characterized as ones that have a redeployment risk. That is, to achieve adequate profitability, the lessor is relying not only on the revenues from the initial lease term and the ultimate sale of the leased asset, but is also relying on the expected frequency of subsequent lease cycles and the anticipated profitability of such subsequent lease cycles. Examples of such tangible assets (or simply “assets”) include, but are not limited to: automobiles, aircraft, ships, shipping containers, trucks, trailers, furniture, houses, and apartments.

One aspect of a lease agreement is its terms. While a particular lessor may get a satisfactory return on equity over a brief number of years, a large number of such lease agreements become unsatisfactory when viewed from the perspective of the profitability of the asset over the entire life of that asset. Redeployment risks are one factor that affects how satisfactory a lease is. It therefore becomes important for a particular lessor to be able to determine how a particular lease, when entered into, would affect the profitability on the underlying asset over its entire life, even after the lease term expires and the asset is redeployed. Such information should be conveyed to the user in a straight-forward and easy to comprehend manner.

In this disclosure, the term “lifecycle profitability” or “LCP” pertains to the profitability of the asset over its entire life, including the duration of the lease as well as any period after the lease terminates in which the asset may be used. The term “life” of an asset pertains to the period during which the asset is economically usable. Lifecycle profitability can be used for assets with varying usable periods, whether such periods are measured in days, months, years, or other time periods.

### Exemplary Computing Environment for LCP Tool

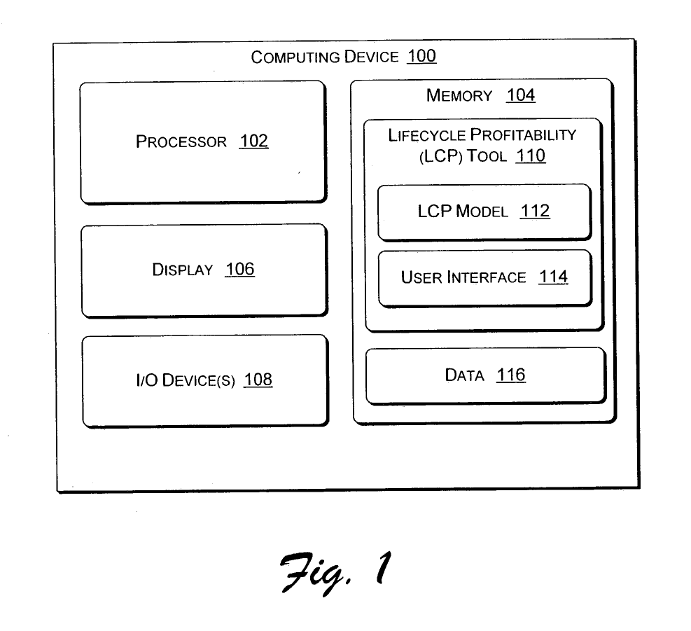

FIG. 1 shows an exemplary computing environment in which a lifecycle profitability (LCP) tool can be implemented. In the illustrated environment, a computing device 100 has a processor 102 (such as a central processing unit), a memory 104 (including volatile and non-volatile memory), a display 106 (e.g., CRT monitor, LCD screen etc.), and one or more input/output (I/O) devices 108 (e.g., keyboard, mouse, touch-screen, voice recognition system, etc.). Although not illustrated, these components 102, 104, 106, and 108 are functionally coupled via data, address, and power connectors. The computing device 100 may be embodied in many different ways, including as a general purpose computer, a portable computer (e.g., laptop), a personal digital assistant (PDA), communication device, and so forth.

A lifecycle profitability (LCP) tool 110 is shown stored in memory 104. In the illustrated implementation, the LCP tool 110 is implemented in software stored in the memory 104 and executed on the processor 102. In other implementations, the LCP tool 110 may be at least partially implemented in hardware or firmware embedded in a custom-designed integrated circuit.

The LCP tool 110 includes an LCP model 112 and a user interface (UT) 114. The LCP model 112 provides the financial functionality to determine a lifecycle profitability of the asset given the terms of a particular lease. The LCP model 112 utilizes financial data 116 to compute the lifecycle profitability based on the user-entered terms. The financial data 116 pertains to the financial analysis of the leasable asset, and may include any number and type of parameters. It can include real-time or time-sensitive data (e.g., interest rates), historical data collected over time from other leases involving similar assets, estimated data, and so forth.

In the computing device shown in FIG. 1, the user interface 114 of the LCP tool 110 is physically separated from the data 116. Encryption tools and techniques may be use to exclude certain or even most users of the user interface 114 from directly accessing the detailed data 116 that is considered confidential to the lessor company. As such, a salesperson for the lessor company will be able to utilize the data 116 using, e.g., his or her laptop user interface 114 that is outfitted with the encryption tools. The salesperson, however, will not be able to access the extensive and highly confidential raw data 116, providing security against unauthorized transfer to third parties either while the salesperson is employed by the lessor or after termination. Such encryption techniques are generally known in the computer industry, and will not be further detailed herein.

The UI 114 is used by the user to accept information relating to the asset from a user into the memory. In addition, the UI displays the result of the lifecycle profitability analysis on the assets to a user. Lease terms for a lease on a particular asset can be entered using the user interface 114. The LCP model 112 computes the lifecycle profitability based on the entered terms and the financial data 116. The results are then presented to the user on the UT 114 using textual, numerical, and graphical techniques, as will be described below in more detail.

The lifecycle profitability tool 110 enables a lessor to determine the financial quality of a particular lease deal. In this disclosure, the term “deal” is considered to be a transaction involving a particular asset. The LCP tool 110 offers a user friendly approach that allows the lessor to enter lease terms at the time of negotiation and see whether the individual lease, given the entered terms, is financially acceptable or not. The results are presented in such a manner to convey the financial quality of the particular lease deal at the time of the lease, as well as over the full lifecycle of the asset. Heuristics are used to alter the presentation depending upon the financial quality of the deal.

The LCP tool may be implemented in a standalone environment, as depicted in FIG. 1. Here, the computing device 100 is equipped with the tool 110 and the data 116 in support of the model 112. An example scenario for this implementation is a salesperson in the field who is using his/her laptop to analyze a potential lease of some asset.

Alternatively, the LCP tool may be implemented in a network environment where the data is served to the client device 100. An example scenario is where a large corporation supports hundreds or thousands of sales personnel by hosting the financial data at backend servers and serving it to the computing devices of the personnel as desired. This implementation is described next.

### Exemplary Networked Environment for LCP Tool

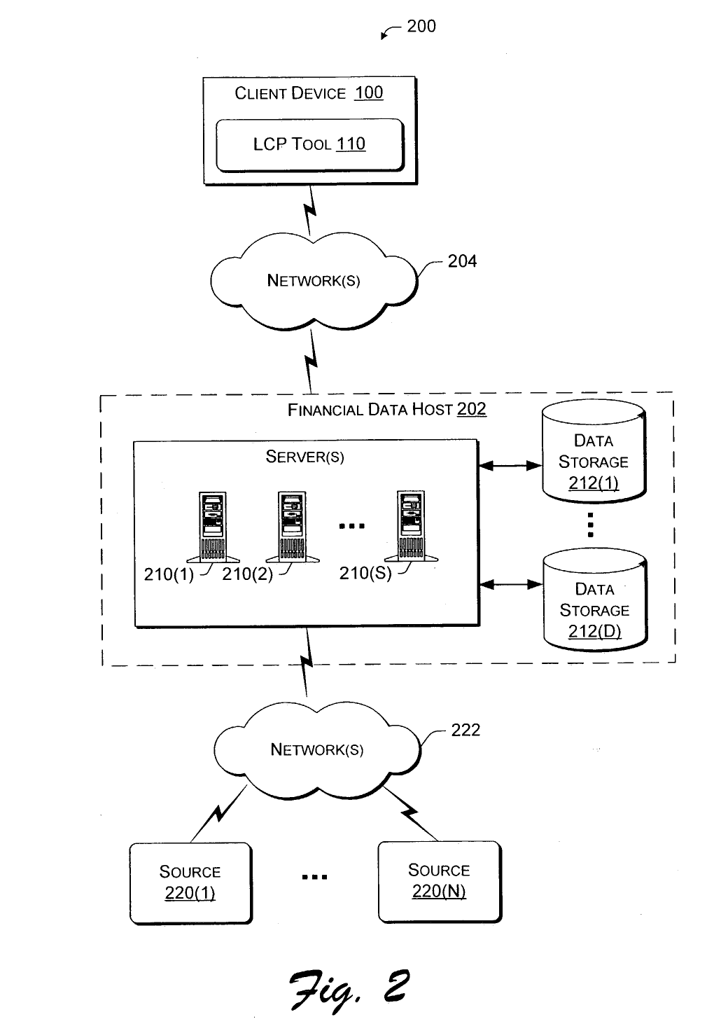

FIG. 2 shows an exemplary networked environment 200 in which the computing device 100 can be networked to a host that supports operation of the lifecycle profitability (LCP) tool 112. In environment 100, the computing device 100 functions as a client device connected with a financial data host 202 via one or more networks 204. The network(s) 204 can be implemented as a corporate intranet, a Wide Area Network (WAN), a local area network (LAN), the Internet, any other networked configuration, or a combination of such networks.

The client device 100 is equipped with the LCP tool 110. Although only one device 100 is illustrated, the host 202 can support interactions with multiple clients, where each client is equipped with the LCP tool 110. The tool 110 may be pre-stored on the computing device or downloaded from the host to the device via network 204.

The financial data host 202 includes one or more servers 210(1), 210(2), . . . , 210(S) connected to one or more data storage units 212(1), . . . , 212(D). Financial data used by the LCP tool 110 is stored on the data storage units 212. The data storage units 212 typically contain a database (e.g., running Structured Query Language [SQL]) that is capable of storing and accessing such financial data. Each server 210 is able to retrieve the data stored in the data storage units 212 and serve that data to the client device 110.

Separately from this server functionality, the host 202 also collects updated data from one or more sources 220(1), . . . , 220(N) over one or more networks 222 (which may or may not be the same as networks 204). The source(s) 220 contain data that might be utilized by the LCP model in the LCP tool 110. Such data can be provided to the financial data host 202 as it becomes available and stored in the storage units 212. In this manner, the most up-to-date data for the LCP tool can be made available for distribution to the client device 100.

### LCP Tool

The lifecycle profitability tool 110 enables a user to evaluate a lease deal involving a tangible asset at the time of negotiation based on the many factors or parameters that impact the profitability of that asset over the asset's entire life. The tool 110 utilizes the financial data stored locally (FIG. 1 implementation) or retrieved from a remote repository (FIG. 2 implementation), as well as lease terms entered by the user, to evaluate the lifecycle profitability of the asset. Examples of parameters that are used by the LCP tool 110 include, but are not limited to: initial cost, rental rates, utilization, maintenance and repair, storage costs, allocations of Sales, General and Administrative (SG&A) expenses, resale values and related costs.

Table 1 lists a more detailed, exemplary set of parameters that can be used in the LCP tool 110 for analyzing an asset.

TABLE 1
LCP Tool Parameters

| Term (parameter) | Definition |
|---|---|
| Average Daily Rate (ADR) | Revenues/Number of ADR days. |
| Average Net Book Value | (NBV at beginning of period + NBV at end of period)/2. |
| (Avg. NBV) | |
| Cum Post-Sales NI/Year | Cumulative Post Sale Net Income/Year = (Total net |
| | income from year one until given age)/unit age. |
| Cum ROE | Cumulative Return of Equity = Cum ROI × Leverage. |
| Cum ROI | Cumulative Return on Investment: For a given age = (Cum |
| | Post-sales NI/YR.)/(Avg. NBV for unit age). |
| Debt Payment | Payment for equity debt. |
| Depreciated Tax (Dep. (Tax)) | Accelerated tax depreciation using values for the first |
| | prescribed number of years. |
| Depreciation | Annual depreciation for this type of equipment. |
| Earning Before Taxes (EBT) | (Revenue) − (Interest) − (M&R) − (SG&A) − (Other) − SRN) − (Tax |
| | Dep.). |
| Equipment Net | Net Profit after paying equipment debt = (Sales net) − (Debt Payment). |
| Equity Debt | Debt after leveraged payment for unit cost. |
| Fleet Count | Number of unit-years in the fleet. (number available |
| | days/365). |
| GOS | Gain on Sale = total sales proceed − net book value |
| Interest | Interest Payment. |
| IRR | Internal Rate of Return. |
| Leverage | Leverage = debt:equity ratio |
| Leveraged Cash Flow | Cash flow using the desired leverage. For year 0, equals |
| | the equity payment, for other years (Pat) + (Tax Dep.). |
| LOS | Loss on Sale = total sales proceed − net book value |
| M&R | Maintenance and repair Cost. |
| NBV | Net Book Value at beginning of period (Unit Cost) − (Total |
| | Depreciation of Unit). |
| Net Income | (Pre Tax) − (Tax). |
| NPV @ Y % | Net Present Value at a Y % (some arbitrary percentage) |
| | discount rate. |
| On Lease | Number of units that were on lease during the period. |
| Other Costs | Goodwill is not included. |
| PAT | Profit After Taxes = (EBT) − (Tax). |
| Post-Sales ROI | 100* (Net Income + Sales Net)/(Avg. NBV). |
| Pre-Sales ROI | Same as ROI, but before sale of unit. |
| Pre-tax | Income Before Taxes = (Revenues) − (Depreciation) − |
| | (Interest) − (SG&A) − (Other costs) + (SRN). |
| Revenue | For a given equipment age = 365 * (Utilization) * (ADR). |
| ROI | Return on Investment = 100* (Net Income)/(Avg. |
| | NBV). |
| Sales NBV | Tax Net Book Value = (Unit Cost) − (Total Tax Dep. |
| | paid until unit is sold). |
| Sales Net | (Sales Revenue) − (Commission) − (Taxes). |
| Sales Revenue | Revenues per Unit Sold. |
| NPV @ IRR | See Above Definitions. |
| SG&A | Sales, general, and administrative expenses. |
| SRN | Service Rebills Net. |
| Taxes | (Tax Rate) * (EBT). |
| Unit Cost | Initial Cost of Unit. |
| Unleveraged Cash flow | Cash flow without leverage. |
| Utilization | 100 * (Number of ADR Days)/Number of Available |
| | Days). |
| UTE | Utilization Rates = Total number of units used/total |
| | number of units |
| Taxes on Unit Sold | (Sales Revenue) − (Commission) − (Tax NBV). |

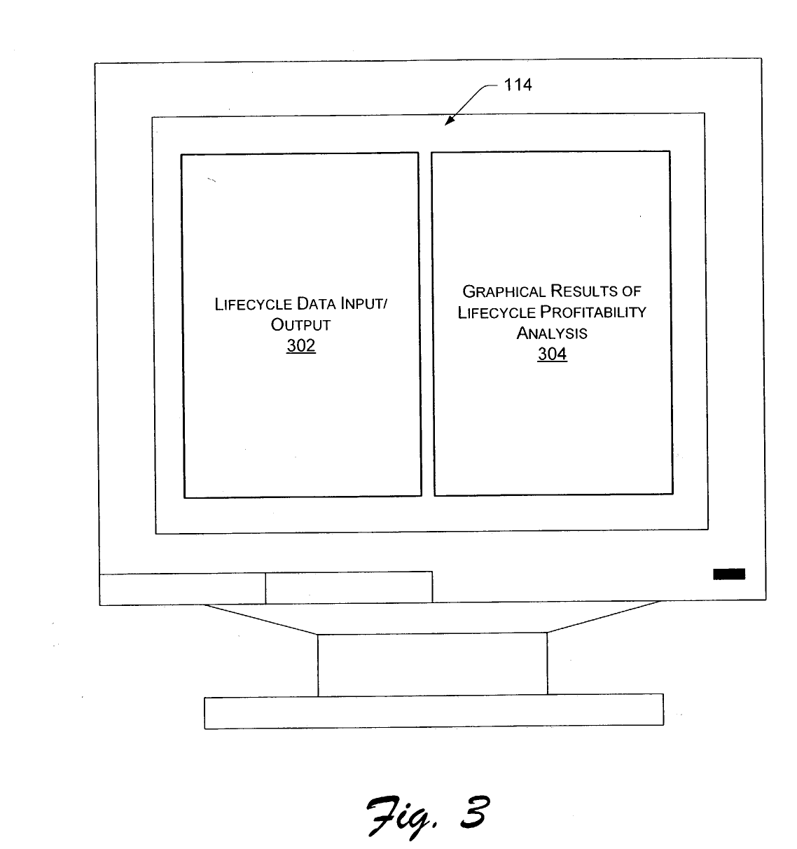

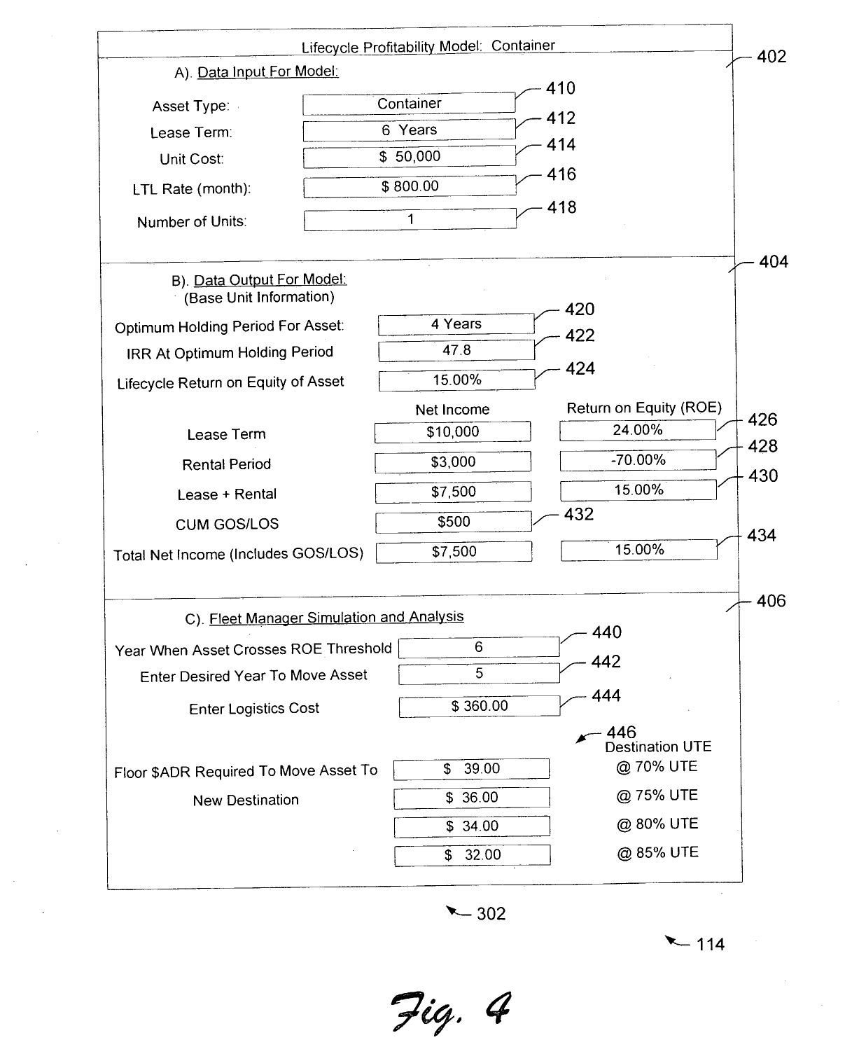

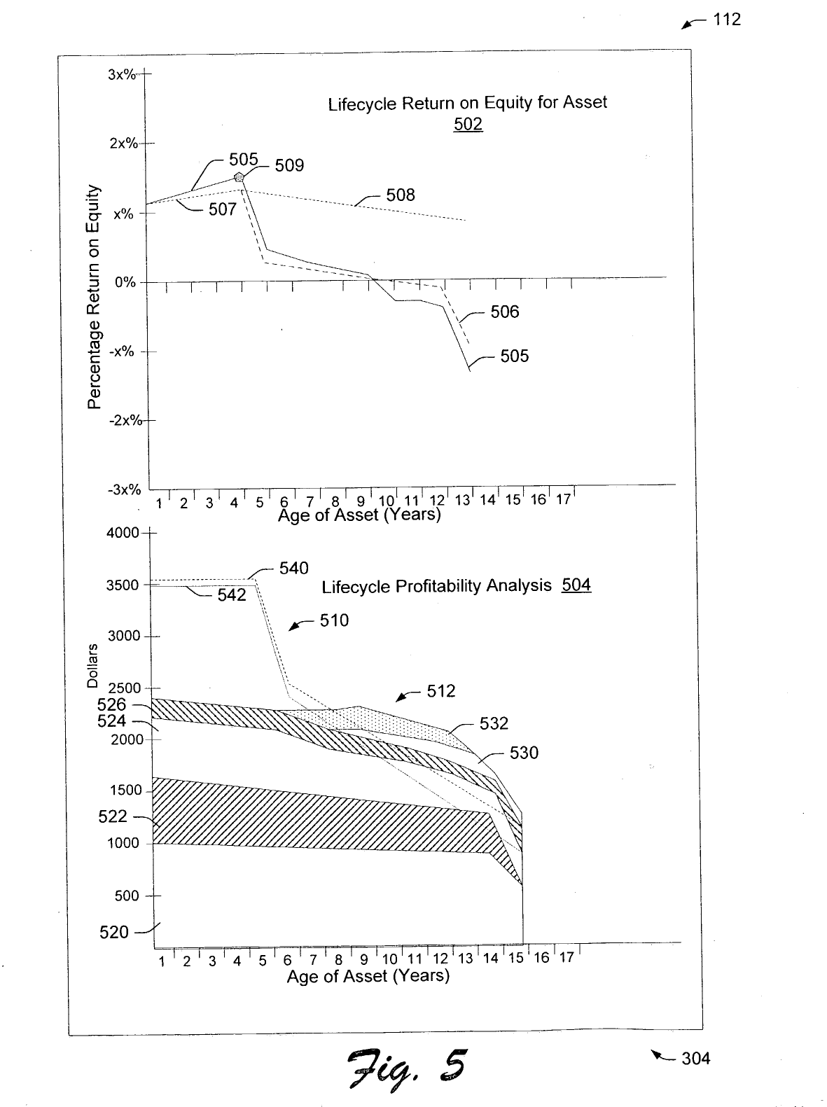

FIG. 3 shows an exemplary user interface 114 that may be presented by the computing device 100 to facilitate entry of lease terms and output of the lifecycle profitability analysis for an individual deal. Associated with the assets are a large number of parameters that may be best displayed graphically to enhance comprehension as to profitability as a function of asset age (vintage). Even for a brand new asset, the vintage measure is used to determine the value of the asset through the life of the asset as the asset ages. In the FIG. 3 implementation, the LCP tool UI 114 is segmented into a lifecycle data input/output region 302 and a graphical results region 304. The lifecycle input/output region 302 facilitates user entry of lease terms, and displays certain results of the lifecycle profitability analysis. One illustrative example of the lifecycle data input/output region 302 (with fictional input and output terms) is shown in FIG. 4. The graphical results region 304 depicts one or more graphs illustrating the lifecycle profitability of the asset given the terms entered in data region 302. One illustrative example of graphical results region 304 having fictional results is illustrated in FIG. 5.

In one implementation, the LCP tool 110 may be configured using a spreadsheet or database application (e.g., Microsoft EXCEL spreadsheet application), where the model 112, including the variables and associated equations, are entered in one or more sheets. In this implementation, the UI 114 is designed to direct a user to enter lease terms into pre-set cells of the spreadsheet. Based on this entry, the tool computes the results and depicts them using various graphs, such as sediment charts and other graphical plots. The results may be presented differently depending upon the financial quality of the lease.

FIG. 4 shows one example of a data input/output region 302 of the LCP tool UT 114. The data input/output region 302 allows a user to quickly review the particular information that is being input into the LCP tool 110, as well as certain information that is being output from the LCP tool 110. The data input/output region 302 is a non-graphical portion of the UI 114. The data input/output region 302 can be viewed simultaneously over the UI 114 with the graphical results region 304 as described relative to FIG. 5 to provide a data interface as well as a graphical data representation of the LCP tool 110.

One version of the lifecycle data input/output region 302 of the LCP tool 110 as shown in FIG. 4 is for an asset. The region 302 includes a data input portion 402, a data output portion 404, and a fleet manager simulation and analysis portion 406. The term “fleet” is used to describe a collection of leasable assets such as shipping containers, trailers, vehicles, houses, etc. The data input portion 402 includes, for example, the asset type 410, the lease term 412, the unit cost 414, the long term lease (LTL) rate 416, and the number of units 418. Other asset types may have slightly modified parameters, but the parameters included herein are illustrative of the types of parameters that are included in the lifecycle data input/output portion 302.

The data input portion 402 thereby includes that type of input that is used to determine whether a particular deal is good. The asset type 410 typically includes a description of the particular type of asset. Though a generalized description of a container is shown in FIG. 4 as an asset for the purpose of illustration, it is envisioned that the asset type 410 includes the make, model, age, and any such particular definition that may be useful in determining the value of the asset.

The lease term 412 describes the length that the lease is expected to last. It is envisioned that the users may modify the lease term 412 (and other factors) several times to produce different computations to indicate how the overall deal varies. The unit cost 414 describes the initial cost of the particular asset. The LTL rate 416 indicates the long term lease rate. The number of units as described relative to 418 is self-explanatory. Other data input categories may be included depending on the particular applicability of the LCP tool.

The data output portion 404 of the data input/output portion 302 indicates the output information that is used by the LCP tool in the UI 114 to determine the LCP. One version of the data output portion 404 includes the optimum holding period for asset 420, the Internal Rate of Return (IRR) at optimum holding period 422, the lifecycle return on equity of asset 424, the lease term 426, the rental period 428 during the economic life of the asset, the lease + rental amount 430, the cumulative GOS/LOS 432 during the economic life of the asset, and the total net income 434. The categories 426, 428, 430, and 434 are subdivided into net income and return on equity portions in the embodiment of the LCP tool 110 shown in FIG. 4.

The optimum holding period for asset 420 within the lifecycle data input/output portion 302 describes the desired number of years (that is less than or equal to the asset life) for holding the asset based on return on equity. The IRR at the optimum holding period describes the Internal Rate of Return for the period determined in 420. The lifecycle return on equity of asset 424 indicates the return on equity during the lifecycle of the asset. The lease term 426 indicates the net income and the return on equity during the rental period. The rental period 428 indicates the net income and the return on equity from the end of the initial lease term to the end of the economic life of the underlying asset. The cumulative gain on sale/loss on sale (GOS/LOS) 432 indicates the net income assigned to a particular asset derived from fleet disposals. The total net income 434 includes the total net income and the cumulative gain on sale/loss on sale (GOS/LOS) through the expected life of the asset.

One embodiment of the manager simulation and analysis portion 406 of the data input/output portion 302 of the LCP tool 110 includes a year when asset crosses the ROE threshold 440, an enter desired year to move asset 442, an enter logistics cost 444, and one or more floor average daily rate (ADR) required to move asset to new destination 446. The year when asset crosses the ROE threshold 440 indicates the year when it is no longer desirable to hold the asset for leasing purposes.

One embodiment of the data input/output portion 302 of the LCP tool 110 includes a heuristic-based display as to the financial quality of a deal. Briefly stated, it is desirable to indicate to the user by color coding or highlighting that a deal falls into some financial quality category such as good, medium, or unsatisfactory. As shown in FIG. 4, for example, the ROE indicator 426 for the lease term in the embodiment of data output for model 404 as described relative to FIG. 4 can change color depending the financial quality of the deal. For example, for a good deal (such as where the ROE exceeds a percentage referred to in this disclosure as “x”), the ROE indicator of 426 can be color coded green. For an acceptable deal (e.g., between x−5 and x percent ROE), the ROE indicator of 426 can be color coded yellow. For a poor deal (e.g., less than x−5 percent), the ROE indicator of 426 can be color coded red. Some other color scheme or threshold value can be used in different embodiments of the LCP tool 110. Certain other indicators in FIG. 4 can also be color coded as can the graphical output as shown in FIG. 5.

The LCP tool 110 as described can be applied to leases on either new assets or used assets. The examples in this disclosure are directed to leases on new assets. To apply the LCP tool to leases on used assets, the user replaces the OEC (Original Equipment Cost, indicated as “unit cost” 414 in FIG. 4) with the equipment value on the lessor's books, or some other reliable indicator of the present value of the used asset and enters the vintage of the asset to be leased. The user then enters the lease term, the lease payment, and other pertinent information in the locations indicated in FIG. 4, and the LCP tool 110 derives the ROE on the remaining life cycle of the used equipment.

The value of the threshold on the ROE may be set into the LCP tool as a portion of the program, or in alternate embodiments can be altered by the user of the LCP tool. In one illustrative example, a “good” ROE is any ROE that is equal to or greater than some prescribed value (e.g., x%). A “satisfactory” ROE may be any ROE that is under the “good” ROE value, but is still at or above another prescribed value (e.g., x−5%). An unsatisfactory ROE is therefore some ROE value that is less than the satisfactory ROE value. The “enter desired year to move asset” field 442 indicates the selected year to sell or otherwise transfer the asset. The “enter the logistics cost” field 444 indicates the cost associated with the logistics. The floor average daily rate (ADR) to move the asset to the new destination 446 includes certain of the shipping expenses. The floor ADR to move the asset to the new transportation 446 includes several displayed values based on the utilization rate (UTE).

In one embodiment, the inputs to the LCP tool 110 include deal terms, debt terms, life terms, disposal profile, revenue assumptions, and cost assumptions. The deal term includes those terms that factor into the initial purchase of the asset such as the equipment type, purchase price, the quantity of the equipment to be purchased, initial LTL term, initial term RV, and the applicable tax rate(s).

In one embodiment, the debt terms include the leverage, the cost of funds (COF), and the debt term. The life terms include, but are not limited to, those terms that relate to the usable life expectancy of the asset. In one embodiment, the life terms include the book life, the economic life, and the residual value.

The disposal profile is the percentage of the fleet of assets disposed by vintage.

The revenue assumptions include, but are not limited to, the use and payment for the asset by the lessee or a subsequent purchaser. The revenue assumptions include the utilization and the average daily rate to be paid on the asset. The cost assumptions of the data input/output portion 302 of the LCP tool 110 therefore include, but are not limited to, those factors that relate to the maintenance and delivery of the asset to the lessee by the lessor.

FIG. 5 illustrates one version of the graphical results region 304 that is shown in FIG. 3. The graphical results region 304 graphically indicates the return on equity on a year-to-year basis. Even though the desired number of years that the asset is to be held may be less than the lease term, the return on equity is plotted for each year of the lease term to provide an indication to certain lenders of a desirable duration to hold the lease. This graphical representation of the return on equity through the life of the lease is presented in a manner that can be clearly and rapidly understood by potential parties to an agreement, salespersons, and the like.

The applicable asset's return on equity (ROE) both on an annual basis and cumulatively through the life of the lease is calculated and displayed graphically in FIG. 5, thus identifying the optimum time for disposal (at the peak in ROE) and the time at which the asset begins producing an unacceptable ROE, which should be the latest point at which a unit is sold.

The graphical results region 304 as illustrated in detail FIG. 5 includes two charts: a lifecycle return on equity for asset chart 502 and a lifecycle profitability analysis chart 504. The lifecycle return on equity for asset chart 502 plots the percentage return on equity as an ordinate as a function of the age of the asset (abscissa). The percentage return on equity is plotted as arbitrary percentages (x, 2, 3, −x, −2x, and −3x) in FIG. 5 to indicate the fictional terms on both the lifecycle return on equity for asset chart 502 and a lifecycle profitability analysis chart 504. The significant aspect of the charts 502 and 504 is that the actual outputs are readily displayed to the users in a manner that they can quickly glean the actual ROE for a particular potential lease. The lifecycle profitability analysis chart 504 plots the lifecycle profitability in dollars (ordinate) as a function of the age of the asset (abscissa). It is also envisioned that heuristics can be applied to the graphical results region 304 as shown in FIG. 5 to indicate whether a deal is a good deal financially, and alternatively which portion of a deal through the life of the lease is acceptable financially. The color coding that is associated with the heuristics can be associated with the value of ROE of a portion of the graph.

The embodiment of the lifecycle return on equity for asset chart 502 shown in FIG. 5 displays a pre-sales ROE plot 505, a post sales ROE plot 506, a cumulative pre-sales ROE plot 507, a cumulative post sale ROE plot 508, and a sell asset indicator 509. The sell asset indicator 509 can be colored or configured to indicate when is a good time to sell the asset, or in other words, when is the deal concerning financial aspects of the leased asset(s) no longer beneficial. Many of the features of the lifecycle return on equity for asset chart 502 and/or the lifecycle profitability analysis portion 504 can be similarly color coded or highlighted to indicate at what point the deal no longer is good. This color coding and heuristics can be plotted on a year-to-year basis to indicate to the potential lessor or its salesperson of the financial quality of a deal.

The pre-sales ROE plot 505 indicates the ROE as a function of time prior to selling the asset. The pre-sales ROE plot 505 can be continued after the sell asset indicator 509 to indicate hypothetically the ROE even following the sale. The post sales ROE plot 506 plots the ROE as a function of age after the asset has been sold.

The sell asset indicator 509 indicates the computed time at which the asset should be sold according to the lifecycle return on equity for asset region 502 based on the LCP tool 110. If the asset is held on longer than indicated by the sell asset indicator 509 (to the right of the sell asset indicator 509 as illustrated in FIG. 5), then the user of the LCP tool will experience a lower ROE than desired. The sell asset indicator 509 therefore provides one heuristic indicator of the ROE. The cumulative pre-sales ROE plot 507 is the pre-sales ROE plot 505 adjusted for GOS/LOS. The cumulative post sales ROE plot 508 is the post sales ROE plot 506 adjusted for GOS/LOS. The specific plots 505, 506, 507, and 508 shown in FIG. 5 are illustrative in nature, and are not intended to be limiting in scope. Some indicator of the ROE should be provided in the graphical results region 304, and some indicator of when the asset should be sold should also be provided in the graphical results region.

The lifecycle profitability analysis portion 504 of the graphical results region 304 within the LCP tool 110 indicates the revenues and costs that affect ROE. The lifecycle profitability analysis includes an indicated revenue portion 510 as a component of sediment chart 512. The LCP tool 110 uses historical data on a variety of parameters to generate the sediment chart of revenue overlaid on costs, identifying in dollars the profitability of an average unit over time. The sediment chart diagrammatically represents each revenue and cost driver associated with the asset over the life of the asset. The sediment chart 512 includes a compilation of the revenues and costs that affect ROE taken as a function of age of the asset. For example, the embodiment of the sediment chart 512 as shown in FIG. 5 includes a plot of the revenues and costs that affect ROE in the sediment chart 512.

In FIG. 5, the illustrated components or sediments in the sediment chart 512 include a depreciation portion 520, an interest portion 522, a Sales, General and Administrative (SG&A) expenses portion 524, an other costs portion 526, a storage portion 530, and a maintenance and repair (M&R) portion 532. Each of the specific components of sediments 520, 522, 524, 526, 530, and 532 is intended to be illustrative, and different components of the sediment chart 512 can include the revenues and costs affecting ROE that are desired. In addition, each specific component of sediments 520, 522, 524, 526, 530, and 532 within the sediment chart 512 can be ordered in any desired order.

The embodiment of indicated revenue portion 510 shown in FIG. 5 includes a base unit revenue plot 540 and an adjusted revenue plot 542. These plots 540 and 542 may be used to give the salesperson an indication regarding how the terms might be modified to achieve the desired goals.

The embodiment of LCP tool 110 as described relative to FIGS. 3, 4, and 5 therefore displays to the user certain input and output values as shown in FIG. 4, as well as the lifecycle return on equity for assets portion 502 and the lifecycle profitability analysis portion 504 over a single display. These particular components may be segmented and displayed as desired in different embodiments of the LCP tool 110. The LCP tool thereby provides an effective tool to indicate to a potential lessor to a lease deal the financial quality of the deal including the desired length of the deal.

Vintage of an asset, which corresponds to the age of the asset, factors in different embodiments of the LCP tool 110. The vintage may dictate the rate of rent of the leasable asset. In one embodiment the cost assumptions include the maintenance and repair, the storage of the asset, the handling of the asset, the incentives to purchase/lease the asset, the SG&A expenses of the asset, and the percentage of bad debts, all of which vary by vintage. The embodiment of the LCP tool 110 (whose displayed outputs are shown in FIGS. 3, 4, and 5) allows a designer of the LCP tool to input different costs like maintenance and repair, storage, handling, etc. in absolute terms by vintage (the age of the particular asset). The costs incurred can be prorated to the remaining group of assets (e.g., fleet of assets) at any point in time. The LCP tool 110 allows flexibility to calculate the SG&A expenses as percentage of revenues or as a percentage of the net book value.

LCP tools are developed based on the characteristics of the assets and the parties involved. Though LCP tool development shares many common aspects for different assets, the development process is preferably distinctly performed for each class of assets. During the development process, the drivers, the cost of overhead, the depreciation, the incidental expenses, the values of drivers, etc. can be used to determine profitability within the LCP tool. Much of the LCP tool development process involves interaction with the salespersons, customers, and managers that are associated and familiar with the assets.

The LCP tool development includes such processes as defining and determining the asset class based on the strategic importance of the assets. The profitability drivers that are associated with the assets can be identified that include such factors as sales, costs, interest, etc. The profitability drivers (or factors) include, e.g., revenue stream, where does the revenue come from, cost drivers, and interest.

Using the drivers, the LCP tool accurately measures the return on equity for each year based on the vintage (age) of the asset. Even for a brand new asset, the history of older assets is used to determine the value of the asset through the life of the asset as the asset ages. The LCP therefore considers the profitability of the asset based on the aging of the asset. This helps the owner of an asset to determine when is a good time to dispose of the asset.

Development of the LCP tool can determine who is the process owner of the LCP tool process to run on the computer environment 100. A process plan can be developed to determine what data is available. The data corresponding to the assets is arranged by vintages.

The LCP tool can be built using, for example, a spreadsheet program or a database program. The structure and operation of the LCP tools can be tested and verified to ensure the drivers and assumptions of the LCP tool are correct. The operation of the LCP tool can be altered to provide more efficient and realistic operation.

In one embodiment, the operation of the LCP tool 110 starts by calculating a detailed monthly profit and loss statement and a cash flow statement. The following broad drivers (i.e., factors or heads) are considered in the calculation: the depreciation, the debt amortization, the long term lease (LTL) and short term rental (STR) revenues, the business specific cost drivers (that include maintenance and repair, storage, handling, and incentives), the SG&A, the gain on the sale/loss on the sale.

Certain embodiments of the LCP tool 110 allow for flexibility to calculate a point-to-point (PTP) depreciation based on initial LTL term as well as straight-line depreciation based on holding period of collateral. Depreciation is calculated on remaining fleet after taking into account the Net Book Value (NBV) of the portfolio disposed by vintage. The tool depreciates the equipment to its end of life Residual Value (RV) based on holding period. The Tool calculates principal, charge, and interest payment based on the leverage ratio and the cost of the funds (COF) of business, and holding period of equipment. The principal and the interest are calculated on the remaining book value of the fleet.

The LTL revenues and the STR revenues are calculated by age of the asset. For calculating revenues generated over a time period, the numbers obtained are multiplied with average units available over the period and number of days in the period. In one embodiment, the tool calculates remarketing GOS/LOS by vintage by offsetting NBV of disposals against Remarketing Proceeds for the particular vintage. The GOS/LOS is prorated to the remaining fleet at any point in time.

One embodiment of the LCP tool 110 generates the following illustrative, but not limiting, outputs including: a) a pre and post-tax cumulative ROI and/or ROE calculations over holding period of collateral; and b) a sediment charts that diagrammatically explain the revenues and costs associated with an asset over its life.

Forward looking user data input (requiring no mining) is used for deriving original equipment cost, point-to-point (PTP), and life residual values, rebates (if applicable), leverage and cost of the funds (COF).

The LCP tool 110 provides for a tool that permits sales personnel (e.g., in the field) to analyze positive or negative aspects of an agreement, and thereby effectively structure and negotiate individual deals. The LCP tool 110 can use a computer-based database or spreadsheet application (such as a Statistical Analysis Software (SAS)) that allows a salesperson or other individuals to vary such parameters as the asset type, lease term, unit cost, monthly rate, etc. on the initial long term lease. One embodiment of the LCP tool outputs a display to the user indicating to such users as the sales person such calculated parameters as the ROE for the lifecycle of the asset, the initial lease term, the balance of the life of the asset, the total lease flows, and the total lease flows plus sale at the end of the useful life.

In one embodiment, one or more of the displayed parameters can be quantitatively displayed (e.g., color coded) to indicate whether that parameter is within current acceptable levels or not, or alternatively how much the displayed parameter is within or out of the acceptable levels. The displayed output of the LCP tool 110 also presents net income for various categories and information for the fleet manager as to when to dispose of the unit and the rental rates required to warrant repositioning an asset for re-lease.

Certain embodiments of the tool using the LCP tool 110 can be made available on an intranet or other network, permitting the sales force access in order to make preliminary pricing and structure decisions. With a web base, it will be possible for the asset management team to control and update the underlying assumptions such as cost of funds, SG&A allocations and revenues and utilization based on new data. Initially such updates will be done manually, but it is anticipated that automated feeds as to certain information may be developed over time.

As such, the LCP tool accurately measures the return on equity for each year based on the vintage (age) of the asset. The LCP therefore considers the profitability of the asset based on its vintage.

### Operation of LCP Tool

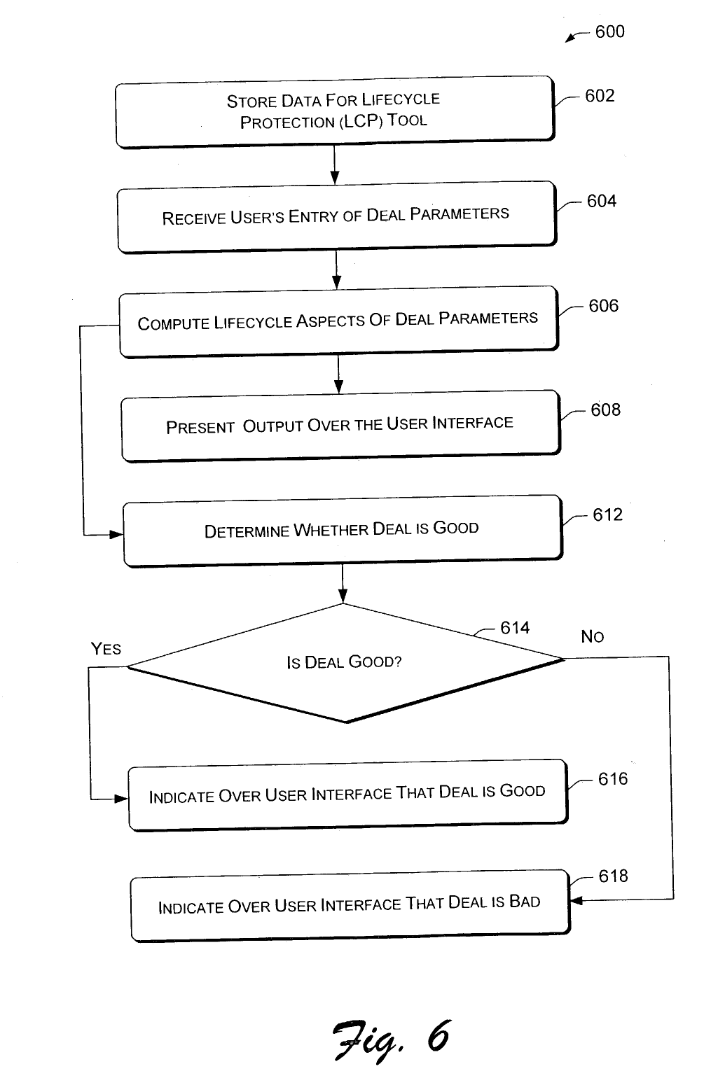

The LCP tool 110, different versions of which are shown in FIGS. 1 and 2, runs using an LCP process 600 as shown in FIG. 6. The LCP process indicates, using a user interface (UI), the profitability or financial quality of a deal. The LCP process 600 includes 602 in which data is provided for the LCP tool 110. In the embodiment shown in FIGS. 1 or 2, the source(s) 155 provide the data to the memory storage(s) 140A and 140B that can be accessed by the server device(s) 106. The data accessed by the server devices 106 can be transferred over the network 104 to the client device 102 based on input from the LCP tool 110.

In 604 of the LCP process 600, the LCP tool received the user's entry of deal parameters. The user typically applies the input using the user interface 212 of the LCP tool 110 as shown in FIG. 2. In 606, the LCP tool computes the lifecycle aspects of the deal parameters. The outputs from the LCP tool are displayed over the user interface in 608 of the LCP process 600.

While 608 of the LCP process 600 displays the actual data to the users, certain embodiments of the LCP tool 110 indicate graphically or with heuristics whether the deal is good, satisfactory, poor, or some other category. As shown in FIG. 6: 612, 614, 616, and 618 of the LCP process 600 indicates the financial quality of the deal. In 612, the LCP tool 110 of the computer environment 100 determines whether the deal is good, bad, or otherwise. The LCP process 600 then continues to 614 in which it is determined whether the deal is good. If the answer to condition 614 is yes, then the LCP process 600 continues to 616 in which the LCP tool 110 indicates that the deal is good. If the answer to 614 is no, then the LCP process 600 continues to 618 in which the LCP tool 110 indicates that the deal is bad. Other deal categories than “good” and “bad” may be included, but the LCP process 600 indicates the generalized logic of one embodiment of the LCP tool.

In one implementation, the LCP tool 110 provides for evaluating new capital expenditures for a given asset. The LCP tool 110 is also able to calculate the cumulative return on equity (hereinafter “ROE”) and/or the instantaneous ROE over the life of the asset. Using the cumulative ROE, the LCP tool 110 can be used to identify an optimum holding period (time) for any asset.

### Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Moreover, these claims are just exemplary of possible scope and subject matter.

1. A system comprising:
a data store to store a collection of data that pertains financially to a leasable asset;
a user interface to facilitate entry of lease terms pertaining to leasing of the leasable asset; and
a processor to compute a lifecycle profitability of the leasable asset based on the data in the data store given the lease terms entered via the user interface.

2. The system as recited in claim 1, wherein the leasable asset has a redeployment risk.

3. The system of claim 1, wherein the tangible asset is selected from a group of assets comprising a truck, automobile, trailer or other vehicle, a cargo container, an aircraft, a computer, and a piece of equipment.

4. The system of claim 1, wherein the data store comprises a memory coupled to the processor.

5. The system of claim 1, wherein the data store comprises one or more data storage units remote from the processor.

6. The system of claim 1, wherein the user interface comprises a data input/output region to facilitate entry of the lease terms and output of results of the lifecycle profitability computation.

7. The system of claim 1, wherein the user interface comprises a results region to present graphically results of the lifecycle profitability computation.

8. The system as recited in claim 1, wherein the user interface indicates a financial quality of the lease.

9. The system as recited in claim 8, wherein the financial quality of the lease is defined by a set of heuristics.

10. The system as recited in claim 8, wherein the user interface presents results of the lifecycle profitability to visually convey the financial quality of the lease.

11. The system as recited in claim 1, wherein the processor computes the lifecycle profitability that extends throughout life of the lease for leasable asset.

12. The system of claim 1, wherein the user interface presents results of the lifecycle profitability computation in a manner that indicates a time for selling the leasable asset.

13. The system of claim 1, wherein the processor computes a cumulative return on equity.

14. The system of claim 1, wherein the processor computes an instantaneous return on equity.

15. The system of claim 1, wherein a duration of the lease is less than an economic life of the leasable asset.

16. An asset evaluating tool, comprising:
a user interface to facilitate entry of a set of lease terms in a lease of an asset; and
a computing unit to compute a return on equity for the asset based on the lease terms.

17. The asset evaluating tool of claim 16, wherein the user interface presents the return on equity for the asset at regular intervals over the asset's life.

18. The asset evaluating tool of claim 16, wherein the user interface visually conveys a financial quality of the lease based on the return on equity.

19. The asset evaluating tool as recited in claim 16, wherein the user interface comprises color indicators to convey a financial quality of the lease.

20. The asset evaluating tool of claim 16, wherein the user interface comprises indicia of a time for selling the asset.

21. A computing device comprising:
a memory;
a processor coupled to the memory; and
a lifecycle profitability (LCP) tool stored in the memory and executed on the processor to facilitate entry of lease terms in a lease for an asset and to evaluate lifecycle profitability of the asset given the lease terms.

22. The computing device of claim 21, wherein the LCP tool comprises a user interface to present results of the evaluation.

23. The computing device of claim 21, wherein the LCP tool comprises a user interface that represents a financial quality of the lease throughout a duration of the lease.

24. The computing device of claim 21, wherein the LCP tool comprises a user interface that presents results of the evaluation graphically to represents a financial quality of the lease over the asset's entire life.

25. An computing device, comprising:
a memory;
a processor coupled to the memory; and
an asset evaluation tool stored in the memory and executed on the processor to measure the return on equity (ROE) of an asset based on a vintage of the asset and terms of a lease of the asset.

26. The computing device of claim 25, wherein the asset evaluation tool provides indicia of a time to sell the asset.

27. The computing device of claim 25, wherein the asset evaluation tool comprises a user interface that presents the return on equity for each year of the asset's life.

28. A user interface comprising:
a first region to enable entry of terms in a lease of an asset; and
a second region to present results of a lifecycle profitability analysis on the asset given the terms entered in the first region.

29. The user interface of claim 28, wherein the first region includes output.

30. The user interface of claim 28, wherein the second region includes color coding of results.

31. The user interface of claim 28, wherein the second region includes charting.

32. The user interface of claim 28, wherein the second region includes sediment charting.

33. A computer readable medium having computer executable instructions, which when executed by a processor, causes the processor to:
receive lease terms for a lease involving a tangible asset; and
compute a lifecycle profitability of the tangible asset based on the lease terms; and
present results of the lifecycle profitability computation.

34. The computer executable instructions to be contained on the computer readable medium as recited in claim 33, wherein the tangible asset has a redeployment risk.

35. The computer executable instructions to be contained on the computer readable medium of claim 33, wherein the tangible asset is selected from a group of assets comprising a truck, automobile, trailer or other vehicle, a cargo container, an aircraft, a computer, and a piece of equipment.

36. The computer executable instructions to be contained on the computer readable medium of claim 33, further comprising:
inserting the computer readable medium into a data store; and
coupling the data store to the processor.

37. The computer executable instructions to be contained on the computer readable medium of claim 36, wherein the data store comprises one or more data storage units remote from the processor.

38. The computer executable instructions to be contained on the computer readable medium of claim 33, further comprising displaying a results region over a user interface to present graphically results of the lifecycle profitability computation.

39. The computer executable instructions to be contained on the computer readable medium as recited in claim 33, wherein a user interface indicates a financial quality of the lease.

40. The computer executable instructions to be contained on the computer readable medium as recited in claim 39, wherein the financial quality of the lease is defined by a set of heuristics.

41. The computer executable instructions to be contained on the computer readable medium as recited in claim 39, wherein the user interface presents results of the lifecycle profitability to visually convey the financial quality of the lease.

42. The computer executable instructions to be contained on the computer readable medium as recited in claim 33, further comprising computing the lifecycle profitability that extends throughout the life of the lease.

43. The computer executable instructions to be contained on the computer readable medium of claim 33, further comprising presenting results of the lifecycle profitability computation in a manner indicating a time to sell the tangible asset.

44. A method comprising:
storing a collection of data that pertains financially to the financial status of a leasable asset;
facilitating entry of lease variables pertaining to leasing of the leasable asset; and
computing a lifecycle profitability of the leasable asset based on the data in the data store given the lease variables entered via a user interface.

45. The method of claim 44, further comprising displaying the lifecycle profitability.

46. The method of claim 44, wherein the leasable asset has a redeployment risk.

47. The method of claim 44, wherein the leasable asset is selected from a group of assets comprising a truck, automobile, trailer or other vehicle, a cargo container, an aircraft, a computer, and a piece of equipment.

48. The method of claim 44, further comprising:
storing the collected data in a data store; and
coupling the data store to a processor.

49. The method of claim 48, wherein the data store comprises one or more data storage units remote from the processor.

50. The method of claim 44, further comprising displaying a results region over a user interface to present graphically results of the lifecycle profitability computation.

51. The method claim 44, wherein a user interface indicates a financial quality of the lease.

52. The method of claim 51, wherein the financial quality of the lease is defined by a set of heuristics.

53. The method of claim 51, wherein the user interface presents results of the lifecycle profitability to visually convey the financial quality of the lease.

54. The method of claim 44, further comprising computing the lifecycle profitability that extends throughout the life of the lease.

55. The method of claim 44, further comprising presenting results of the lifecycle profitability computation in a manner indicating a time to sell the leasable asset.

56. A computing system, further comprising:
a data store to store a collection of data that pertains financially to a leasable asset;
a user interface to facilitate entry of lease terms pertaining to leasing of the leasable asset.
a processor to compute a lifecycle profitability of the leasable asset based on the data in the data store given the lease terms entered via the user interface; and
an encryption tool that limits accessing of data in the data store to only a certain group of users via the user interface.
